(19) United States
(12) Patent Application Publication
(10) Pub. No.: US 2009/0192250 A1
(43) Pub. Date: Jul. 30, 2009

(54) THERMOPLASTIC ELASTOMER COMPOSITION AND COMPOSITE MOLDING

(75) Inventors: Yasuhito IJICHI, Chiba (JP); Kohsuke Ohtani, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/353,326

(22) Filed: Jan. 14, 2009

(30) Foreign Application Priority Data
Jan. 29, 2008 (JP) 2008-017655

(51) Int. Cl. C08K 3/38; C08L 53/02; C08K 3/10; C08K 3/34; C08K 3/22; C08K 3/30

(52) U.S. Cl. 524/405; 524/505; 524/423; 524/413; 524/451; 524/447; 524/449; 524/456

(57) ABSTRACT

A thermoplastic elastomer composition is provided that contains 1 to 20 parts by weight of component (E), wherein the thermoplastic elastomer composition is provided by a process for producing a thermoplastic elastomer composition including the steps of: (1) dynamically heat treating 5 to 25 parts by weight of component (A), 10 to 70 parts by weight of component (B), 3 to 25 parts by weight of component (C), and 10 to 70 parts by weight of component (D) in the presence of a crosslinking agent to obtain a mixture, wherein component (A) is a polypropylene resin, component (B) is an ethylene-α-olefin copolymer rubber, component (C) is a hydrogenated vinyl aromatic compound-conjugated diene block copolymer, component (D) is a mineral oil, component (E) is an inorganic filler having an aspect ratio of at least 2, and the total amount of components (A) to (D) is 100 parts by weight.

### TECHNICAL FIELD

The present invention relates to a thermoplastic elastomer composition and a composite molding in which the thermoplastic elastomer composition and a polyolefin resin are thermally bonded.

### BACKGROUND ART

Thermoplastic elastomer compositions have excellent flexibility and elastic recovery, can be molded by normal molding machines for thermoplastic resins, and do not require a vulcanization step during the molding process, and due to such features they are suitably used in various applications such as automobile components, electrical components, and general-purpose products and, in particular, packings, sealants, gaskets, etc. As moldings used in such applications, a molding formed from a thermoplastic elastomer composition on its own and a composite molding having a soft member comprising a thermoplastic elastomer composition and a hard member comprising a polyolefin resin, etc. are used.

For example, JP-A-2001-279052 (JP-A denotes a Japanese unexamined patent application publication.) proposes a thermoplastic elastomer composition obtained by dynamically heat treating in the presence of an organic peroxide a polypropylene resin, an ethylene-propylene-ethylidene norbornene copolymer rubber, a styrene-ethylene-ethylene-propylene-styrene block copolymer, and a mineral oil, and proposes a sealant made of the thermoplastic elastomer composition. Furthermore, JP-A-9-316286 proposes a thermoplastic elastomer composition obtained by dynamically heat treating in the presence of an organic peroxide a polypropylene resin, an ethylene-propylene-ethylidene norbornene copolymer rubber, a hydrogenated styrene-butadiene-styrene block copolymer, and a mineral oil to partially crosslink, and proposes a composite molding in which the thermoplastic elastomer composition and a polypropylene resin are thermally bonded.

### DISCLOSURE OF INVENTION

However, with regard to the conventional thermoplastic elastomer compositions, a molding might shrink after molding or when the molding is used at high temperature, and when the shrinkage of a molding is high, if it is used as a sealant, the sealing function might deteriorate, and if it is used as a gasket fitted into another component, excessive stress might be imposed on the gasket to thus degrade the durability of the gasket; furthermore, if it is formed as a composite molding with a polyolefin resin, deformation such as warping might be caused in the composite molding, and the conventional thermoplastic elastomer composition is thus not necessarily satisfactory in terms of the dimensional stability of a molding.

Under such circumstances, it is an object of the present invention to provide a thermoplastic elastomer composition giving a molding with excellent dimensional stability, and a composite molding in which the thermoplastic elastomer composition and a polyolefin resin are thermally bonded.

The present invention provides a process for producing a thermoplastic elastomer composition, comprising the steps of:

(1) dynamically heat treating
5 to 25 parts by weight of component (A),
10 to 70 parts by weight of component (B),
3 to 25 parts by weight of component (C), and
10 to 70 parts by weight of component (D)

in the presence of a crosslinking agent to obtain a mixture, and

(2) mixing 1 to 20 parts by weight of component (E) prior to, during or after the dynamical heat treatment, wherein

component (A) is a polypropylene resin,

component (B) is an ethylene-α-olefin copolymer rubber,

component (C) is a hydrogenated vinyl aromatic compound-conjugated diene block copolymer,

component (D) is a mineral oil,

component (E) is an inorganic filler having an aspect ratio of at least 2, and

the total amount of components (A) to (D) is 100 parts by weight.

The present invention provides a process for producing a composite molding, comprising the step of thermally bonding a polyolefin resin and a thermoplastic elastomer composition obtained by the above process.

The present invention provides a thermoplastic elastomer composition, comprising 1 to 20 parts by weight of component (E), wherein the thermoplastic elastomer composition is obtained by a process for producing a thermoplastic elastomer composition comprising the steps of:

(1) dynamically heat treating
5 to 25 parts by weight of component (A),
10 to 70 parts by weight of component (B),
3 to 25 parts by weight of component (C), and
10 to 70 parts by weight of component (D)

in the presence of a crosslinking agent to obtain a mixture, wherein

component (A) is a polypropylene resin,

component (B) is an ethylene-α-olefin copolymer rubber,

component (C) is a hydrogenated vinyl aromatic compound-conjugated diene block copolymer,

component (D) is a mineral oil,

component (E) is an inorganic filler having an aspect ratio of at least 2, and

the total amount of components (A) to (D) is 100 parts by weight.

Furthermore, the present invention provides a composite molding in which a polyolefin resin and the thermoplastic elastomer composition as described above are thermally bonded.

### MODE FOR CARRYING OUT THE INVENTION

Component (A) is a polypropylene resin. Examples of the polypropylene resin include preferably a propylene homopolymer, a copolymer of a propylene and an α-olefin having at least 2 carbons (excluding propylene), more preferably a copolymer of a propylene and an α-olefin having 2 to 10 carbons (excluding propylene). The copolymer may be a random copolymer or an impact copolymer which is a mixture of propylene homopolymer and propylene-ethylene random copolymer. Examples of the α-olefin having at least 2 carbons include ethylene, 1-butene, 1-pentene, 3-methyl-1-butene, 1-hexene, 1-decene, 3-methyl-1-pentene, 4-methyl-1-pentene, and 1-octene, preferably ethylene.

With regard to the polypropylene resin, the content of monomer unit based on the α-olefin having at least 2 carbons is less than 50 wt % relative to 100 wt % of the polypropylene resin.

The polypropylene resin has a melt flow rate (MFR) of preferably 0.1 to 300 g/10 minutes and, from the viewpoint of enhancing processability, more preferably 0.1 to 150 g/10 minutes. MFR is measured in accordance with JIS K7210 under conditions of a temperature of 230° C. and a load of 21.18 N.

Component (B) is an ethylene-α-olefin copolymer rubber. As used herein, the term “ethylene-α-olefin copolymer rubber” comprises copolymers consisting of ethylene-based monomer units and α-olefin-based monomer units; copolymers consisting of ethylene-based monomer units, α-olefin-based monomer units and one or more other types of monomer units, particularly nonconjugated polyene-based monomer units; and mixtures of these copolymers. Examples of the ethylene-α-olefin copolymer rubber include an ethylene-α-olefin copolymer rubber consisting of ethylene-based monomer units and α-olefin-based monomer units; an ethylene-1-olefin-nonconjugated polyene copolymer rubber; and a mixture of ethylene-α-olefin copolymer rubber consisting of ethylene-based monomer units and α-olefin-based monomer units and an ethylene-α-olefin-nonconjugated polyene copolymer rubber.

Examples of the α-olefin in the ethylene-α-olefin copolymer rubber include propylene, 1-butene, 1-pentene, 1-hexene, 4-methyl-1-pentene, 1-octene, and 1-decene, preferably an α-olefin having 3 to 10 carbons, more preferably propylene, 1-butene, and 1-octene.

With regard to the ethylene-α-olefin copolymer rubber, the content of the α-olefin-based monomer unit is preferably 10 to 50 wt %, more preferably at least 10 wt % but less than 50 wt % and, from the viewpoint of enhancing flexibility and mechanical strength, yet more preferably 20 to 40 wt %, where the ethylene-α-olefin copolymer rubber is defined as 100 wt %.

The content of the ethylene-based monomer unit in the ethylene-α-olefin copolymer rubber is preferably at least 50 wt %, where the ethylene-α-olefin copolymer rubber is defined as 100 wt %.

Examples of a nonconjugated polyene in the ethylene-α-olefin copolymer rubber include an aliphatic nonconjugated diene such as 1,4-hexadiene, 1,6-octadiene, 2-methyl-1,5-hexadiene, 6-methyl-1,5-heptadiene, or 7-methyl-1,6-octadiene; a cyclic nonconjugated diene such as cyclohexadiene, dicyclopentadiene, methyltetrahydroindene, 5-vinylnorbornene, 5-ethylidene-2-norbornene, 5-methylene-2-norbornene, 5-isopropylidene-2-norbornene, or 6-chloromethyl-5-isopropenyl-2-norbornene; and a triene such as 2,3-diisopropylidene-5-norbornene, 2-ethylidene-3-isopropylidene-5-norbornene, 2-propenyl-2,2-norbornadiene, 1,3,7-octatriene, or 1,4,9-decatriene, and preferably 5-ethylidene-2-norbornene and dicyclopentadiene.

When the ethylene-α-olefin-nonconjugated polyene copolymer rubber is used, the content of the nonconjugated polyene-based monomer unit is preferably 5 to 40 as an iodine value (i.e. the content of the nonconjugated polyene-based monomer unit is adjusted so that the iodine value of the ethylene-α-olefin-nonconjugated polyene copolymer rubber is preferably 5 to 40 g iodine per 100 g ethylene-α-olefin-nonconjugated polyene copolymer rubber).

From the viewpoint of enhancing the mechanical strength and mechanical strength of a molding, the ethylene-α-olefin-nonconjugated polyene copolymer rubber has a Mooney viscosity (ML₁₊₄ 100° C.) at 100° C. of preferably 10 to 350, and more preferably 30 to 200. Mooney viscosity at 100° C. is measured in accordance with JIS K6300.

It is also possible to employ components (B) and (D) in the form of an oil-extended rubber comprising these components. As noted above, component (B) may be a mixture of an ethylene-α-olefin copolymer rubber consisting of ethylene-based monomer units and α-olefin-based monomer units and an ethylene-α-olefin-nonconjugated polyene copolymer rubber, and it is preferable for it to comprise an ethylene-α-olefin-nonconjugated polyene copolymer rubber.

Component (C) is a compound obtained by hydrogenating a vinyl aromatic compound-conjugated diene block copolymer. Examples of the vinyl aromatic compound include styrene, α-methylstyrene, p-methylstyrene, vinylxylene, monochlorostyrene, dichlorostyrene, monobromostyrene, dibromostyrene, ethylstyrene, and vinylnaphthalene, and preferably styrene.

Examples of the conjugated diene compound of the vinyl aromatic compound-conjugated diene block copolymer include butadiene, isoprene, 2,3-dimethyl-1,3-butadiene, 2-neopentyl-1,3-butadiene, 2-chloro-1,3-butadiene, and 2-cyano-1,3-butadiene, and preferably butadiene and isoprene.

The vinyl aromatic compound-conjugated diene block copolymer may be one comprising two blocks having different structures or one comprising three or more blocks. Examples of one comprising two blocks include a copolymer having a styrene homopolymer block-butadiene homopolymer block structure and a copolymer having a styrene homopolymer block-isoprene homopolymer block structure, and examples of one comprising three or more blocks include a copolymer having a styrene homopolymer block-butadiene homopolymer block-styrene homopolymer block structure, a copolymer having a styrene homopolymer block-isoprene homopolymer block-styrene homopolymer block structure, a copolymer having a styrene homopolymer block-butadiene/isoprene copolymer block-styrene homopolymer block structure, and a copolymer having a styrene homopolymer block-styrene/butadiene copolymer block-styrene homopolymer block structure; in such copolymers the styrene/butadiene copolymer block may be a block having a structure in which styrene and butadiene are randomly copolymerized, or a block having a tapered structure in which the styrene unit content gradually decreases or increases.

From the viewpoint of enhancing heat resistance and weatherability, the degree of hydrogenation of the hydrogenated vinyl aromatic compound-conjugated diene block copolymer, that is, with the amount of double bonds in the conjugated diene compound-based monomer unit in the block copolymer prior to hydrogenation as 100%, among the double bonds, the amount of double bonds that are hydrogenated by hydrogenation of the block copolymer is preferably at least 80%, and more preferably at least 90%.

The content of the vinyl aromatic compound-based monomer unit in the hydrogenated vinyl aromatic compound-conjugated diene block copolymer is preferably 5 to 40 wt % and, from the viewpoint of enhancing flexibility and scratch resistance, more preferably 10 to 35 wt %, where the hydrogenated vinyl aromatic compound-conjugated diene block copolymer is defined as 100 wt %. The content of the conjugated diene-based monomer unit in the hydrogenated vinyl aromatic compound-conjugated diene block copolymer is preferably 95 to 60 wt %, and more preferably 90 to 65 wt %, where the hydrogenated vinyl aromatic compound-conjugated diene block copolymer is defined as 100 wt %. The content of the vinyl aromatic compound-based monomer unit is measured by a proton nuclear magnetic resonance (¹H-NMR) method.

The hydrogenated vinyl aromatic compound-conjugated diene block copolymer has a weight-average molecular weight of preferably at least 100,000 and, from the viewpoint of reducing tackiness of a thermoplastic elastomer composition, more preferably at least 150,000. The weight-average molecular weight is a weight-average molecular weight on a polystyrene basis, and is measured by a gel permeation chromatography (GPC).

Component (D) is a mineral oil. Examples of the mineral oil include an aromatic mineral oil, a naphthenic mineral oil, and a paraffinic mineral oil, and a paraffinic mineral oil is preferable.

Component (E) is an inorganic filler. Examples of the inorganic filler include talc, mica, kaolin, and acicular forms of glass fiber, carbon fiber, wollastonite, potassium titanate, basic magnesium sulfate, and aluminum borate. These inorganic fillers may be surface-treated with a surfactant, a coupling agent, a metallic soap, etc. before use. The surface-treated inorganic filler is effective in further improving molding appearance, mechanical strength balance, dimensional stability, etc. of a molding.

The inorganic filler has an aspect ratio of at least 2, preferably at least 3, more preferably at least 5, and yet more preferably at least 10. When the aspect ratio is too small, after molding the thermoplastic elastomer composition or when using a molding at high temperature the dimensional stability of the molding might deteriorate. The aspect ratio of the inorganic filler can be determined from the ratio of the major axis to the minor axis when examining the inorganic filler by means of an optical microscope, a scanning electron microscope, a transmission electron microscope, etc.

With regard to the thermoplastic elastomer composition, relative to 100 parts by weight of the total amount of components (A) to (D), 5 to 25 parts by weight of component (A), 10 to 70 parts by weight of component (B), 3 to 25 parts by weight of component (C), and 10 to 70 parts by weight of component (D) are dynamically heat treated in the presence of a crosslinking agent, and 1 to 20 parts by weight of component (E) is mixed therewith prior to, during or after the dynamical heat treatment. The ‘dynamically heat treating’ referred to in the present invention means melt-kneading being carried out.

When the amount of component (A) is too small, the flowability and heat resistance might decrease, and when a composite molding is formed the strength of the thermal bond might decrease, and when the amount of component (A) is too large, rubber characteristics such as flexibility and compression set might deteriorate. When the amount of component (B) is too small, rubber characteristics such as compression set might decrease, and when the amount of component (B) is too large, the flowability might decrease. When the amount of component (C) is too small, the tack resistance and scratch resistance might decrease, and when the amount of component (C) is too large, the flowability and heat resistance might decrease. When the amount of component (D) is too small, the flexibility and flowability might decrease, and when the amount of component (D) is too large, the mechanical strength and tack resistance might decrease. When the amount of component (E) is too small, after the thermoplastic elastomer composition is molded and when a molding is used at high temperature the dimensional stability of the molding might deteriorate, and when the amount of component (E) is too large, the flexibility and flowability might decrease and when a composite molding is formed the strength of the thermal bond might decrease.

The crosslinking agent used when carrying out a dynamical heat treatment may be any crosslinking agent as long as it can crosslink an ethylene-α-olefin copolymer rubber which is component (B). Examples of the crosslinking agent include an organic peroxide, a phenol resin crosslinking agent, a sulfur-based crosslinking agent, and preferably an organic peroxide.

Examples of the organic peroxide include 2,5-dimethyl-2,5-di(t-butylperoxy)hexane, 2,5-dimethyl-2,5-di(t-butylperoxy)hexyne-3, 1,3-bis(t-butylperoxyisopropyl)benzene, 1,1-di(t-butylperoxy)-3,5,5-trimethylcyclohexane, 2,5-dimethyl-2,5-di(peroxybenzoyl)hexyne, and dicumylperoxide, and from the viewpoint of reducing odor and enhancing the operability of the dynamical heat treatment, preferably 2,5-dimethyl-2,5-di(t-butylperoxy)hexane and 2,5-dimethyl-2,5-di(t-butylperoxy)hexyne-3.

From the viewpoint of enhancing compression set resistance and economic efficiency, the amount of crosslinking agent used in the dynamical heat treatment is preferably 0.005 to 2 parts by weight, and more preferably 0.01 to 0.6 parts by weight, relative to 100 parts by weight of the total amount of components (A) to (D).

The dynamical heat treatment may employ a crosslinking coagent. Examples of the crosslinking coagent include N,N′-m-phenylenebismaleimide, tolylenebismaleimide, p-quinone dioxime, nitrosobenzene, diphenylguanidine, trimethylolpropane, divinylbenzene, ethylene glycol dimethacrylate, polyethylene glycol dimethacrylate, trimethylolpropane trimethacrylate, and allyl methacrylate.

In addition to components (A) to (E), an antioxidant (phenol-based, sulfur-based, phosphorus-based, lactone-based, vitamin-based, etc.), a weathering stabilizer, a UV absorber (benzotriazole-based, triazine-based, anilide-based, benzophenone-based, etc.), a heat stabilizer, a photostabilizer (hindered amine-based, benzoate-based, etc.), a lubricant (fatty acid amide, fatty acid metal salt, silicone oil, wax, etc.), an antistatic agent (fatty acid ester, alkylamine derivative, aliphatic sulfonic acid salt, etc.), a pigment, etc. may be mixed with the thermoplastic elastomer composition.

When the thermoplastic elastomer composition is used in applications where it is in contact with a metal (copper, iron, etc.) that accelerates the degradation of a polymer, in addition to components (A) to (E), it is preferable to add a metal deactivator (component (F)) to the thermoplastic elastomer composition.

Examples of the metal deactivator, which is component (F), include a hydrazide-based compound, a salicylic acid derivative, and an oxalic acid derivative. Examples of the hydrazide-based compound include 2′,3-bis{[3-(3,5-di-t-butyl-4-hydroxyphenyl)propinonyl]}propionohydrazide, isophthalic acid bis(2-phenoxypropionylhydrazide), and oxalyl bis(benzylidene hydrazide). Examples of the salicylic acid derivative include N-formyl-N′-salicyloylhydrazine, decamethylenedicarboxylic acid disalicyloyl hydrazide, and 3-(N-salicyloyl)amino-1,2,4-triazole. Examples of the oxalic acid derivative include 2,2-oxamidobis[ethyl-3-(3,5-di-t-butyl-4-hydroxyphenyl)propionate].

From the viewpoint of enhancing metal deactivation, the amount of component (F) is preferably 0.01 to 3 parts by weight, more preferably 0.05 to 2.5 parts by weight, and yet more preferably 0.1 to 2 parts by weight, relative to 100 parts by weight of the total amount of components (A) to (D).

From the viewpoint of enhancing the mechanical strength, flexibility, and rubber characteristics, the durometer A hardness of the thermoplastic elastomer composition is preferably 10 to 90, more preferably 10 to 55, and yet more preferably 20 to 55. The durometer A hardness is measured in accordance with JIS K7215.

A process for producing the thermoplastic elastomer composition is a process in which component (A), component (B), component (C), and component (D) are dynamically heat treated in the presence of a crosslinking agent to obtain a mixture, and component (E) is mixed therewith prior to, during or after the dynamical heat treatment.

Dynamical heat treatment of component (A), component (B), component (C), and component (D) in the presence of a crosslinking agent, and mixing of each component are carried out by, for example, melt-kneading by means of a twin-screw extruder, a Banbury mixer, etc. When a Banbury mixer is used, kneading is preferably carried out at 150° C. to 300° C. for 1 to 30 minutes. When a twin-screw extruder is used, kneading is preferably carried out at 180° C. to 300° C. for a few tens of seconds to a few minutes.

When mixing component (D), the whole amount thereof may be added at once, but it is preferable to mix it in multiple stages selected from among (i), (ii), (iii), etc. below.

(i) Component (D) is mixed with component (B) prior to the dynamical heat treatment in the presence of a crosslinking agent.
(ii) Component (D) is mixed with component (C) prior to the dynamical heat treatment in the presence of a crosslinking agent.
(iii) Component (D) is mixed when carrying out the dynamical heat treatment in the presence of a crosslinking agent.

Component (E) may be mixed at any time prior to the dynamical heat treatment of components (A), (B), (C), and (D) in the presence of a crosslinking agent, when the dynamical heat treatment is carried out, or after the dynamical heat treatment has been carried out, but from the viewpoint of enhancing the dimensional stability of a molding after the thermoplastic elastomer composition is molded and when the molding is used at high temperature, it is preferable that mixing is carried out after components (A), (B), (C), and (D) have been dynamically heat treated in the presence of a crosslinking agent.

When component (F) is used, it is preferable that component (F) is mixed after components (A), (B), (C), and (D) have been dynamically heat treated in the presence of a crosslinking agent, and it is more preferable that after components (A), (B), (C), and (D) have been dynamically heat treated in the presence of a crosslinking agent, component (F) is mixed at the same time as component (E) or after component (E) is mixed.

The thermoplastic elastomer composition gives a molding with low shrinkage and also gives a molding with low shrinkage when used at high temperature; the dimensional stability of the molding is thus excellent. Because of this, it is suitably used for a composite molding formed by thermally bonding with a polyolefin resin.

Examples of the polyolefin resin include a polyethylene resin and a polypropylene resin.

Examples of the polyethylene resin include an ethylene homopolymer, an ethylene-α-olefin copolymer, an ethylene-vinyl acetate copolymer, an ethylene-(meth)acrylic acid copolymer, and an ethylene-(meth)acrylic acid ester copolymer. Examples of the ethylene homopolymer include high pressure low density polyethylene and high density polyethylene. Examples of the ethylene-α-olefin copolymer include an ethylene-1-butene copolymer, an ethylene-1-hexene copolymer, an ethylene-1-octene copolymer, and an ethylene-4-methyl-1-pentene copolymer.

Examples of the polypropylene resin include a propylene homopolymer, a propylene-ethylene random copolymer, and an impact copolymer which is a mixture of propylene homopolymer and propylene-ethylene random copolymer.

The polyolefin resin may be used either singly or in combination. It may be reinforced by an inorganic filler such as glass fiber or talc to thus enhance the rigidity. The polyolefin resin is preferably a polypropylene resin, and more preferably a polypropylene resin reinforced with an inorganic filler.

As a method for forming a composite molding, various known molding methods such as a T die laminate molding method, a coextrusion molding method, a multiple layer blow molding method, and an injection molding method (insert injection molding method, two-color injection molding method (mold rotation system, core back system), a sandwich injection molding method, an injection press molding method, etc.) can be cited. In the case of injection molding, either of the polyolefin resin or the thermoplastic elastomer composition may be molded first. The molding method is preferably an injection molding method, and more preferably a two-color injection molding method. Preferred examples of the composite molding include a molding formed by two-color injection molding in which the core material layer comprises a polyolefin resin and the skin layer comprises the thermoplastic elastomer composition.

Moldings employing the thermoplastic elastomer composition of the present invention may be used as various industrial components. They may be used as automobile components, for example, a hood interior component such as a hood side; an automobile exterior component such as a side molding or a protector; a sealing component such as an air conditioner damper seal, a body seal, or a weather strip; or an automobile interior component such as a center console box, a glove box, an arm rest, or an assist grip. For example, a composite molding formed by two-color molding from a high rigidity polypropylene resin reinforced with an inorganic filler and the thermoplastic elastomer composition of the present invention is suitably used as a sealing component for an automobile.

Furthermore, in consumer electrical appliances they may be used as housings, various cover components, etc., and in building material applications they may be used as building gaskets, jointing materials, etc.

In accordance with the present invention, there can be provided a thermoplastic elastomer composition giving a molding with excellent dimensional stability, and a composite molding in which the thermoplastic elastomer composition and a polyolefin resin are thermally bonded.

### EXAMPLES

The present invention is explained in more detail below by reference to Examples and Comparative Examples.

Methods for the evaluation of physical properties and starting materials used were as follows.

(1) Melt Flow Rate (MFR, Units: g/10 Minutes)

Measured in accordance with JIS K7210 with a load of 49 N at a temperature of 230° C. for compositions obtained from Examples and Comparative Examples and with a load of 21.18 N at a temperature of 230° C. for polypropylene resin.

### (2) Mooney Viscosity (ML₁₊₄, 100° C.)

Measured in accordance with JIS K6300 at a test temperature of 100° C.

### (3) Ethylene Content

Measured by infrared spectroscopy.

### (4) Iodine Value

The oil in an oil-extended ethylene-propylene-5-ethylidene-2-norbornene copolymer rubber was extracted with a solvent, and the ethylene-propylene-5-ethylidene-2-norbornene copolymer rubber thus obtained was compression-molded by means of a hot press, thus molding a film having a thickness of 0.5 mm. The molar amount of double bonds in the rubber was calculated from a peak attributable to 5-ethylidene-2-norbornene (wavenumber 1688 cm⁻¹) obtained by an infrared spectrometer using the film as a measurement sample, and converted into an iodine value.

### (5) Styrene Content

The styrene content in the hydrogenated styrene-butadiene-styrene block copolymer was measured by proton nuclear magnetic resonance (¹H-NMR) spectroscopy.

### (6) Weight-Average Molecular Weight

Measured by gel permeation chromatography (GPC) under conditions 1) to 8) below.

1) Device: Waters 150 C manufactured by Waters
2) Separation column: TOSOH TSK gel GMH6-HT

### 3) Temperature: 140° C.

4) Carrier: ortho-dichlorobenzene
5) Flow rate: 1.0 mL/min
6) Amount injected: 500 μL
7) Detector: differential refractometer
8) Molecular weight standard material: standard polystyrene

### (7) Aspect Ratio

An inorganic filler was subjected to gold vapor deposition, an image was then taken by a scanning electron microscope, the aspect ratio was measured for each inorganic filler particle in the image obtained, and a number-average value for 30 particles was calculated.

### (8) Specific Gravity

A test piece was cut out from a flat sheet of a thermoplastic elastomer composition, and measurement was carried out in accordance with JIS K7112.

### (9) Hardness

In accordance with JIS K7215, a test piece was stamped from a flat sheet of a thermoplastic elastomer composition, and the durometer A hardness was measured.

### (10) Tensile Physical Properties

In accordance with JIS K6251, a test piece stamped from a flat sheet of a thermoplastic elastomer composition by means of JIS 3 dumbbell was used, a tensile test was carried out at a stretching speed of 200 mm/min, and the 100% elongation stress, tensile stress at break, and tensile elongation at break were determined.

### (11) Compression Set

Measured in accordance with JIS K6262 at 70° C. for 22 hours.

### (12) Mold Shrinkage

After a flat sheet of a thermoplastic elastomer composition was molded, it was stored in a constant temperature and humidity chamber at a temperature of 23° C. and a humidity of 50% for 24 hours, the dimensions of the flat sheet after storage were measured, and the mold shrinkage relative to the dimensions of the mold was determined.

### (13) Thermal Shrinkage

A flat sheet of a thermoplastic elastomer composition was stored in an oven at 80° C. for 24 hours, and then conditioned in a constant temperature and humidity chamber at a temperature of 23° C. and a humidity of 50% for 2 hours. After the conditioning, the dimensions of the flat sheet were measured, and the shrinkage of the flat sheet relative to the dimensions prior to storage in the oven at 80° C. was determined.

### (14) Resistance to Damage by Copper

A test piece having a JIS K6251 No. 1 shape, prepared by stamping a flat sheet of a thermoplastic elastomer composition using a stamping blade, was subjected to measurement of initial tensile elongation at break and tensile elongation at break after treatment with copper powder as described below, and the ratio of the tensile elongation at break after treatment with copper powder relative to the initial tensile elongation at break (elongation retention) was determined.

### (Initial Tensile Elongation at Break)

A tensile test was carried out at a test speed of 200 mm/min using the test piece at 23° C. and a humidity of 50% RH, tensile elongation at break was determined, and this tensile elongation at break was defined as the initial tensile elongation.

(Tensile Elongation at Break after Treatment with Copper Powder)

A test piece to which a substantially uniform thickness of 0.03 g of copper powder having a particle size of about 60 μm was attached on one side in a region having a length of 20 mm in the middle of reference lines 40 mm apart and a width of 5 mm in the middle of the test piece width of 10 mm was subjected to a thermal treatment in an oven at 120° C. for 100 hours, and after the thermal treatment the copper powder was removed from the test piece surface. The test piece from which the copper powder had been removed was subjected to a tensile test at a test speed of 200 mm/minute, tensile elongation at break was determined, and this elongation at break was defined as the tensile elongation at break after treatment with copper powder.

### (15) Adhesion

A rectangular test piece having a length of 150 mm, a width of 25 mm, and a thickness of 3 mm was cut out from a composite molding so that the length of polyolefin resin material was 75 mm and the length of thermoplastic elastomer composition material was 75 mm. The rectangular test piece was conditioned under conditions of low temperature (−30° C., 168 hours), normal temperature (23° C., 168 hours), and high temperature (80° C., 168 hours), and the peel strength between the polyolefin resin material and the thermoplastic elastomer composition material was measured by carrying out a tensile test at a stretching speed of 500 mm/min.

### (1) Polypropylene Resin

A-1: polypropylene (trade name: NOBLEN D101, manufactured by Sumitomo Chemical Co., Ltd., MFR=0.5 g/10 minutes)

### (2) Ethylene-α-Olefin Copolymer Rubber

B-1: oil-extended ethylene-propylene-5-ethylidene-2-norbornene copolymer rubber (Mooney viscosity ML₁₊₄ 100° C.=46, ethylene content=65%, iodine value=20, rubber/extender oil=100 parts by weight/100 parts by weight)

### (3) Hydrogenated Vinyl Aromatic Compound-Conjugated Diene Block Copolymer

C-1: hydrogenated styrene-butadiene-styrene block copolymer (trade name: Kraton G1651, manufactured by Kraton Polymers Japan Ltd., styrene content 33 wt %, weight-average molecular weight 320,000)

### (4) Mineral Oil

D-1: paraffinic mineral oil (trade name: Diana Process Oil PW-90, manufactured by Idemitsu Kosan Co., Ltd.)

### (5) Inorganic Filler

E-1: basic magnesium sulfate fiber (trade name: MOS-HIGE, manufactured by Ube Material Industries, Ltd., aspect ratio=30)
E-2MB: master batch containing 80 wt % of talc (aspect ratio=3)
E-3MB: master batch containing 80 wt % of calcium carbonate (aspect ratio=1)

### (6) Crosslinking Agent

2,5-dimethyl-2,5-di(t-butylperoxy)hexyne-3 (trade name: Kayabutyl YD, manufactured by Kayaku Akzo Corporation)

### (7) Crosslinking Coagent

N,N′-m-Phenylenebismaleimide (trade name: Sumifine BM, manufactured by Sumitomo Chemical Co., Ltd.)

### (8) Additives

Antioxidant: tetrakis[methylene-3-(3′,5′-di-t-butyl-4-hydroxyphenyl)propionate] methane (trade name: Sumilizer BP101, manufactured by Sumitomo Chemical Co., Ltd.)
Photostabilizer: 2-(2-hydroxy-3-t-butyl-5-methylphenyl)-5-chlorobenzotriazole (trade name: Sumisorb 300, manufactured by Sumitomo Chemical Co., Ltd.,)
Lubricant: oleamide (trade name: Armoslip CPH, manufactured by Lion Akzo Co., Ltd.)
Metal deactivator: 2′,3-bis{[3-(3,5-di-t-butyl-4-hydroxyphenyl)propionyl]}propionohydrazide (trade name: IRGANOX MD1024, manufactured by Ciba Specialty Chemicals)

### Example 1

### Preparation of Thermoplastic Elastomer Composition

As step (1), a Banbury mixer was charged with 52 parts by weight of ethylene-α-olefin copolymer rubber B-1, kneading was carried out for about 1 minute, 5 parts by weight of the hydrogenated product of a vinyl aromatic compound-conjugated diene block copolymer C-1 and 18 parts by weight of mineral oil D-1 were then added to the Banbury mixer, and kneading was carried out for about 2 minutes.

As step (2), 10 parts by weight of polypropylene resin A-1, 15 parts by weight of mineral oil D-1, 0.2 parts by weight of the crosslinking agent, 0.4 parts by weight of the crosslinking coagent, and 5 parts by weight of inorganic filler E-1 were added to the Banbury mixer after step (1), and kneading was carried out for about 7 minutes after the resin temperature attained 180° C.

As step (3), 0.2 parts by weight of the antioxidant, 0.2 parts by weight of the photostabilizer, and 0.5 parts by weight of the lubricant were added to the Banbury mixer after step (2), kneading was carried out for about 3 minutes, and the kneaded material was molded into pellets by an extruder installed beneath the Banbury mixer, thus giving a thermoplastic elastomer composition. The physical properties of the thermoplastic elastomer composition were shown in Table 1.

### Preparation of Flat Sheet

The thermoplastic elastomer composition thus obtained was injection-molded using an injection molding machine (Model IS100-EN, manufactured by Toshiba Machine Co., Ltd., mold clamping force 100 ton) at a cylinder temperature of 220° C. and a mold temperature of 50° C., thus giving a flat sheet having 2 mm thickness×150 mm length×90 mm width. The physical properties of the flat sheet were shown in Table 1.

### Preparation of Composite Molding

Two-color injection molding was carried out using a polyolefin resin and the thermoplastic elastomer composition so obtained to give a 3 mm thick flat sheet in which the polyolefin resin and the thermoplastic elastomer composition were thermally bonded on side faces. As the polyolefin resin, a polypropylene resin containing mica or talc was used. The adhesion of the composite molding were shown in Table 2.

### Example 2

A thermoplastic elastomer composition was prepared in the same manner as in Example 1 except that in step (3) 0.2 parts by weight of the metal deactivator was further charged. The results were shown in Table 1.

### Example 3

A thermoplastic elastomer composition and a flat sheet were prepared in the same manner as in Example 1 except that in step (2) the amount of inorganic filler E-1 charged was 10 parts by weight. The results were shown in Table 1.

### Comparative Example 1

A thermoplastic elastomer composition and a flat sheet were prepared in the same manner as in Example 1 except that in step (2) the inorganic filler E-1 was not charged. The results were shown in Table 1.

### Example 4

As step (1), a Banbury mixer was charged with 51 parts by weight of ethylene-α-olefin copolymer rubber B-1, kneading was carried out for about 1 minute, 5 parts by weight of the hydrogenated product of a vinyl aromatic compound-conjugated diene block copolymer C-1 and 18 parts by weight of mineral oil D-1 were then added to the Banbury mixer, and kneading was carried out for about 2 minutes.

As step (2), 11 parts by weight of polypropylene resin A-1, 15 parts by weight of mineral oil D-1, 0.2 parts by weight of the crosslinking agent, and 0.4 parts by weight of the crosslinking coagent were added to the Banbury mixer after step (1), and kneading was carried out for about 7 minutes after the resin temperature attained 180° C.

As step (3), 0.2 parts by weight of the antioxidant, 0.2 parts by weight of the photostabilizer, 0.5 parts by weight of the lubricant, and 2.5 parts by weight of inorganic filler E-2MB (2 parts by weight as inorganic filler) were added to the Banbury mixer after step (2), kneading was carried out for about 3 minutes, and the kneaded material was molded into pellets by an extruder installed beneath the Banbury mixer, thus giving a thermoplastic elastomer composition. The results were shown in Table 3.

### Preparation of Flat Sheet

The thermoplastic elastomer composition thus obtained was made into a flat sheet in the same manner as in Example 1. The physical properties of the flat sheet were shown in Table 3.

### Preparation of Composite Molding

A 3 mm thick flat sheet in which polyolefin resin and thermoplastic elastomer composition were thermally bonded on side faces was prepared in the same manner as in Example 1. The adhesion of the composite molding was shown in Table 2.

### Example 5

A thermoplastic elastomer composition was prepared in the same manner as in Example 4 except that in step (3) the amount of inorganic filler E-2MB charged was 11.25 parts by weight (9 parts by weight as inorganic filler) and, furthermore, inorganic filler E-3MB was charged at 6.25 parts by weight (5 parts by weight as inorganic filler). The results were shown in Table 3.

### Example 6

A thermoplastic elastomer composition was prepared in the same manner as in Example 5 except that in step (3) 0.2 parts by weight of the metal deactivator was further charged. The results were shown in Table 3.

### Comparative Example 2

A thermoplastic elastomer composition and a flat sheet were prepared in the same manner as in Example 1 except that in step (2) the inorganic filler E-1 was not charged and in step (3) inorganic filler E-3MB was charged at 6.25 parts by weight (5 parts by weight as inorganic filler). The results were shown in Table 3.

### Comparative Example 3

A thermoplastic elastomer composition and a flat sheet were prepared in the same manner as in Example 1 except that in step (2) the inorganic filler E-1 was not charged and in step (3) inorganic filler E-3MB was charged at 12.5 parts by weight (10 parts by weight as inorganic filler). The results were shown in Table 3.

TABLE 1

| | | Ex. | Ex. | Ex. | Comp. |
|---|---|---|---|---|---|
| | | 1 | 2 | 3 | Ex. 1 |
| Production process | | | | | |
| Step (1) | | | | | |
| B-1 | Parts by weight | 52 | 52 | 52 | 52 |
| C-1 | Parts by weight | 5 | 5 | 5 | 5 |
| D-1 | Parts by weight | 18 | 18 | 18 | 18 |
| Step (2) | | | | | |
| A-1 | Parts by weight | 10 | 10 | 10 | 10 |
| D-1 | Parts by weight | 15 | 15 | 15 | 15 |
| Crosslinking | Parts by weight | 0.2 | 0.2 | 0.2 | 0.2 |
| agent | | | | | |
| Crosslinking | Parts by weight | 0.4 | 0.4 | 0.4 | 0.4 |
| coagent | | | | | |
| E-1 | Parts by weight | 5 | 5 | 10 | — |
| Step (3) | | | | | |
| Antioxidant | Parts by weight | 0.2 | 0.2 | 0.2 | 0.2 |
| Photostabilizer | Parts by weight | 0.2 | 0.2 | 0.2 | 0.2 |
| Lubricant | Parts by weight | 0.5 | 0.5 | 0.5 | 0.5 |
| Metal deactivator | Parts by weight | — | 0.2 | — | — |
| Physical properties | | | | | |
| MFR | g/10 minutes | 8.2 | 5.3 | 7.9 | 11.9 |
| Specific gravity | — | 0.91 | 0.91 | 0.93 | 0.88 |
| Hardness | — | 37 | 36 | 42 | 36 |
| Tensile | | | | | |
| characteristics | | | | | |
| 100% elongation | MPa | 1.0 | 1.3 | 1.1 | 1.4 |
| stress | | | | | |
| Tensile stress at | MPa | 2.3 | 2.5 | 2.3 | 2.9 |
| break | | | | | |
| Tensile | % | 360 | 320 | 330 | 360 |
| elongation at | | | | | |
| break | | | | | |
| Compression set | % | 29 | 29 | 32 | 27 |
| Mold shrinkage | % | 2.8 | 2.8 | 1.9 | 3.7 |
| Thermal | % | 1.5 | 1.6 | 1.4 | 2.6 |
| shrinkage | | | | | |
| Resistance to | % | 37 | 93 | — | — |
| damage by copper | | | | | |
| Elongation | | | | | |
| retention | | | | | |

TABLE 2

| Polyolefin resin | | | Ex. 1 | Ex. 4 |
|---|---|---|---|---|
| Talc-containing | | | | |
| polypropylene resin | | | | |
| Conditioning | low temperature | Kgf | 1.0 | 1.1 |
| | normal temperature | | 1.1 | 1.1 |
| | high temperature | | 0.9 | 1.1 |

Mica-containing
polypropylene resin

| | | | | |
|---|---|---|---|---|
| Conditioning | low temperature | Kgf | 1.1 | 1.3 |
| | normal temperature | | 1.0 | 1.1 |
| | high temperature | | 1.1 | 1.3 |

TABLE 3

| | | Ex. | Ex. | Ex. | Comp. | Comp. |
|---|---|---|---|---|---|---|
| | | 4 | 5 | 6 | Ex. 2 | Ex. 3 |
| Production process | | | | | | |
| Step (1) | | | | | | |
| B-1 | Parts by weight | 51 | 51 | 51 | 52 | 52 |
| C-1 | Parts by weight | 5 | 5 | 5 | 5 | 5 |
| D-1 | Parts by weight | 18 | 18 | 18 | 18 | 18 |
| Step (2) | | | | | | |
| A-1 | Parts by weight | 11 | 11 | 11 | 10 | 10 |
| D-1 | Parts by weight | 15 | 15 | 15 | 15 | 15 |
| Crosslinking agent | Parts by weight | 0.2 | 0.2 | 0.2 | 0.2 | 0.2 |
| Crosslinking coagent | Parts by weight | 0.4 | 0.4 | 0.4 | 0.4 | 0.4 |
| Step (3) | | | | | | |
| Antioxidant | Parts by weight | 0.2 | 0.2 | 0.2 | 0.2 | 0.2 |
| Photostabilizer | Parts by weight | 0.2 | 0.2 | 0.2 | 0.2 | 0.2 |
| Lubricant | Parts by weight | 0.5 | 0.5 | 0.5 | 0.5 | 0.5 |
| E-2MB | Parts by weight | 2.5 | 11.25 | 11.25 | — | — |
| E-3MB | Parts by weight | — | 6.25 | 6.25 | 6.25 | 12.5 |
| Metal deactivator | Parts by weight | — | — | 0.2 | — | — |
| Physical properties | | | | | | |
| MFR | g/10 minutes | 17.0 | 19.7 | 13.7 | 10.2 | 10.2 |
| Specific gravity | — | 0.90 | 0.96 | 0.96 | 0.92 | 0.96 |
| Hardness | — | 47 | 49 | 44 | 40 | 43 |
| Tensile characteristics | | | | | | |
| 100% elongation stress | MPa | 1.4 | 1.5 | 1.5 | 1.3 | 1.3 |
| Tensile stress at break | MPa | 3.9 | 3.2 | 3.2 | 2.3 | 2.4 |
| Tensile elongation at break | % | 450 | 410 | 390 | 320 | 300 |
| Compression set | % | 24 | 29 | 30 | 29 | 29 |
| Mold shrinkage | % | 2.0 | 1.8 | 1.9 | 3.1 | 3.1 |
| Thermal shrinkage | % | 0.9 | 0.9 | 0.9 | 1.9 | 1.7 |
| Resistance to damage by copper | % | — | 43 | 93 | — | — |
| Elongation retention | | | | | | |

1. A process for producing a thermoplastic elastomer composition, comprising the steps of:
(1) dynamically heat treating
5 to 25 parts by weight of component (A),
10 to 70 parts by weight of component (B),
3 to 25 parts by weight of component (C), and
10 to 70 parts by weight of component (D)
in the presence of a crosslinking agent to obtain a mixture, and
(2) mixing 1 to 20 parts by weight of component (E) prior to, during or after the dynamical heat treatment, wherein
component (A) is a polypropylene resin,
component (B) is an ethylene-α-olefin copolymer rubber,
component (C) is a hydrogenated vinyl aromatic compound-conjugated diene block copolymer,
component (D) is a mineral oil,
component (E) is an inorganic filler having an aspect ratio of at least 2, and
the total amount of components (A) to (D) is 100 parts by weight.

2. The process according to claim 1, further comprising a step of mixing 0.01 to 3 parts by weight of component (F) with the mixture after the step (1), wherein
component (F) is a metal deactivator.

3. The process according to claim 1, wherein the thermoplastic elastomer composition has a durometer A hardness of 10 to 55.

4. The process according to claim 1, wherein component (A) is a propylene homopolymer or a copolymer of propylene and an α-olefin having at least 2 carbons.

5. The process according to claim 1, wherein component (B) comprises an ethylene-α-olefin-nonconjugated diene copolymer rubber.

6. The process according to claim 1, wherein component (B) comprises an ethylene-α-olefin-5-ethylidene-2-norbornene copolymer and/or an ethylene-α-olefin-dicyclopentadiene copolymer rubber.

7. The process according to claim 1, wherein the crosslinking agent is an organic peroxide.

8. The process according to claim 1, wherein the inorganic filler is selected from the group consisting of talc, mica, kaolin, glass fiber, carbon fiber, wollastonite, potassium titanate, basic magnesium sulfate, and aluminum borate.

9. The process according to claim 1, wherein the inorganic filler is basic magnesium sulfate.

10. The process according to claim 1, further comprising the step of mixing component (B), component (C) and a part of component (D) prior to step (1).

11. A process for producing a composite molding, comprising the steps of (1) and (2) in the process according to claim 1, and the step of thermally bonding a polyolefin resin and a thermoplastic elastomer composition obtained by the steps of (1) and (2).

12. A thermoplastic elastomer composition, comprising 1 to 20 parts by weight of component (E), wherein the thermoplastic elastomer composition is obtained by a process for producing a thermoplastic elastomer composition comprising the steps of:
(1) dynamically heat treating
5 to 25 parts by weight of component (A),
10 to 70 parts by weight of component (B),
3 to 25 parts by weight of component (C), and
10 to 70 parts by weight of component (D)
in the presence of a crosslinking agent to obtain a mixture, wherein
component (A) is a polypropylene resin,
component (B) is an ethylene-α-olefin copolymer rubber,
component (C) is a hydrogenated vinyl aromatic compound-conjugated diene block copolymer,
component (D) is a mineral oil,
component (E) is an inorganic filler having an aspect ratio of at least 2, and
the total amount of components (A) to (D) is 100 parts by weight.

13. The composition according to claim 12, further comprising 0.01 to 3 parts by weight of (F) a metal deactivator.

14. The composition according to claim 12, having a durometer A hardness of 10 to 55.

15. The composition according to claim 12, wherein component (A) is a propylene homopolymer or a copolymer of propylene and an α-olefin having at least 2 carbons.

16. The composition according to claim 12, wherein component (B) comprises an ethylene-α-olefin-nonconjugated diene copolymer rubber.

17. The composition according to claim 12, wherein component (B) comprises an ethylene-α-olefin-5-ethylidene-2-norbornene copolymer and/or an ethylene-α-olefin-dicyclopentadiene copolymer rubber.

18. The composition according to claim 12, wherein the crosslinking agent is an organic peroxide.

19. The composition according to claim 12, wherein the inorganic filler is selected from the group consisting of talc, mica, kaolin, glass fiber, carbon fiber, wollastonite, potassium titanate, basic magnesium sulfate, and aluminum borate.

20. The composition according to claim 12, wherein the inorganic filler is basic magnesium sulfate.

21. A composite molding in which a polyolefin resin and the thermoplastic elastomer composition according to claim 12 are thermally bonded.
